(19) United States
(12) Patent Application Publication
(10) Pub. No.: US 2018/0203724 A1
(43) Pub. Date: Jul. 19, 2018

(54) FAST TASK DISPATCHING USING A DISPATCHING PROCESSOR

(71) Applicant: INTERNATIONAL BUSINESS MACHINES CORPORATION, Armonk, NY (US)

(72) Inventor: Peter D. Driever, Poughkeepsie, NY (US)

(21) Appl. No.: 15/407,490

(22) Filed: Jan. 17, 2017

(51) Int. Cl. G06F 9/48; G06F 9/50

(52) U.S. Cl. CPC G06F 9/485; G06F 9/4881; G06F 9/5038

(57) ABSTRACT

Examples of techniques for fast task dispatching using a dispatching processor are disclosed. In one example implementation according to aspects of the present disclosure, a computer-implemented method may include: analyzing, based on a list of resources maintained by a dispatcher processor, a task from a suspended queue to determine whether the task is waiting for a resource in order to execute; determining whether the task is waiting for a resource in order to execute; responsive to determining that the task is not waiting for the resource in order to execute, placing the task on a ready queue and adding an address of the resource to the list of resources maintained by the dispatcher processor; and dispatching the task to one of a plurality of execution processors for execution.

### BACKGROUND

The present disclosure generally relates to computer processing systems and, more particularly, relates to a dedicated dispatcher processor to dispatch tasks for execution by other processors in a computer processing system.

Computer processing systems may utilize multiple processors arranged in a parallel processor complex to process tasks in parallel. This enables the processors to execute tasks simultaneously. For example, a large task may be divided into smaller tasks which can then be executed simultaneously or concurrently by the parallel processors of the parallel processor complex. Multi-core processors may also implement parallel processing techniques to execute tasks in parallel threads.

### SUMMARY

According to examples of the present disclosure, techniques including methods, systems, and/or computer program products for fast task dispatching using a dispatching processor are provided. An example method may include analyzing, based on a list of resources maintained by a dispatcher processor, a task from a suspended queue to determine whether the task is waiting for a resource in order to execute. The method may further include determining whether the task is waiting for a resource in order to execute. The method may further include responsive to determining that the task is not waiting for the resource in order to execute, placing the task on a ready queue and adding an address of the resource to the list of resources maintained by the dispatcher processor. The method may further include dispatching the task to one of a plurality of execution processors for execution.

Additional features and advantages are realized through the techniques of the present disclosure. Other aspects are described in detail herein and are considered a part of the disclosure. For a better understanding of the present disclosure with the advantages and the features, refer to the following description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages thereof, are apparent from the following detailed description taken in conjunction with the accompanying drawings in which:

FIG. 1 illustrates a block diagram of a processing system for fast task dispatching using a dispatching processor according to examples of the present disclosure;

FIG. 2 illustrates a flow diagram of a method for fast task dispatching using a dispatching processor according to examples of the present disclosure;

FIG. 3 illustrates a flow diagram of a method for fast task dispatching using a dispatching processor according to examples of the present disclosure; and

FIG. 4 illustrates a block diagram of a processing system for implementing the techniques described herein according to examples of the present disclosure.

### DETAILED DESCRIPTION

Various implementations are described below by referring to several examples of fast task dispatching using a dispatching processor. One processor from a group of processors can be designated as a dispatcher processor to dispatch work to the other processors in the group for processing. Other processors that are not the dispatching processor look for work units (tasks) that are ready to begin execution. The present techniques utilize a list of requested resources maintained in a dispatcher processor such that only a single task is placed on a ready queue for a given resource for a single pass through the dispatching code.

Existing approaches utilize a latched locking operation for common resources. Many tasks may be suspended waiting for a single common resource that was previously held by an executing task but is now available. The dispatching processor looks at each task and, if the resource that the task is currently waiting for (“suspended waiting for) is available, the dispatching processor removes the task from the suspended queue and places it onto a “ready” queue. The ready queue is used by the other processors (i.e., the processors other than the dispatching processor) to identify work/tasks to execute.

Since there are potentially many tasks suspended waiting for a common resource, many or all of these tasks may end up on the ready queue. However, since only one task can hold (i.e., lock) the resource for use at one time, the other tasks that attempt to get the latch after being taken from the ready queue discover that the resource is unavailable. The processors then return to the suspended queue, which creates non-productive work and a reduction in system efficiency.

The present techniques avoid unproductive work while still enabling fast task dispatching. In particular, the present techniques utilize a list of requested resources maintained in the dispatcher processor such that only a single task is placed on the ready queue for a given resource for a single pass through the dispatching code.

Example embodiments of the disclosure include or yield various technical features, technical effects, and/or improvements to technology. Example embodiments of the disclosure provide fast task dispatching using a dispatching processor. In particular, a dedicated dispatcher processor maintains a list of resources that tasks may need before they can be executed, and the dispatcher processor only releases tasks to a ready queue for execution if the necessary resources are available. These aspects of the disclosure constitute technical features that yield the technical effect of preventing putting a task on a ready queue if a resource is not free (i.e., because it is being used by a previous task), which eliminates the overhead of transferring tasks to a ready list and other processors for execution when the resource is not available. As a result of these technical features and technical effects, a processing system in accordance with example embodiments of the disclosure represents an improvement to dispatching techniques. It should be appreciated that the above examples of technical features, technical effects, and improvements to technology of example embodiments of the disclosure are merely illustrative and not exhaustive.

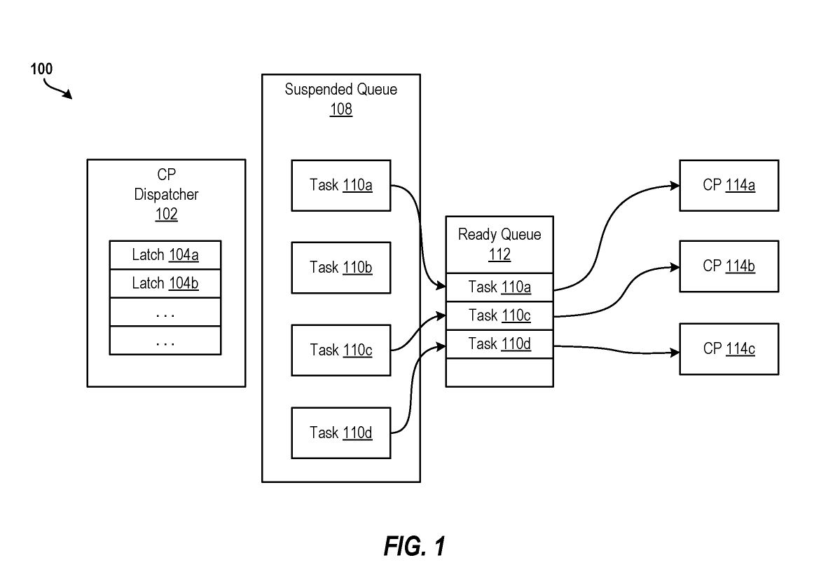

FIG. 1 illustrates a block diagram of a processing system 100 for fast task dispatching using a dispatching processor according to examples of the present disclosure. The various components, modules, engines, etc. described regarding FIG. 1 may be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these. In examples, the engine(s) described herein may be a combination of hardware and programming. The programming may be processor executable instructions stored on a tangible memory, and the hardware may include a processing device for executing those instructions. Thus a system memory can store program instructions that when executed by a processing device implement the engines described herein. Other engines may also be utilized to include other features and functionality described in other examples herein.

The processing system 100 may include a plurality of processors including processors 114a, 114b, 114c, and 102. It should be appreciated that the processors 114a, 114b, 114c are labeled “CP” in FIG. 1, and that the processor 102 is designated as a CP dispatcher to dispatch work to the other processors 114a, 114b, 114c. Alternatively or additionally, the processing system 100 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

A list (array) that represents requested resources is maintained in local storage of the dispatcher processor (e.g., the CP dispatcher 102). When the CP dispatcher 102 proceeds down a list of tasks (e.g., tasks 110a, 110b, 110c, 100d, etc.) that are suspended (i.e., tasks on a suspended queue 108), the CP dispatcher 102 maintains a list (or array) of latches (e.g., latches 104a, 104b, etc.) that an individual task is waiting for and found to be available (task can be put on the ready queue). The list (or array) of latches provides addresses of resources. The tasks may be task control blocks (TCBs).

Any subsequent tasks that are also in the suspended queue 108 that are waiting for a resource are checked to see if the resource is the same as any that are already in the list (array) of the CP dispatcher 102 for which a previous task is waiting. If this is true, that task is not placed on the ready queue 112 and remains instead on the suspended queue 108. If the task is waiting for a resource that is not indicated as an address in this list (array), it is placed on the ready queue 108 and the address of the latch (resource) is added to the list of the CP dispatcher 102. This continues until the suspended queue 108 has been completely traverse (i.e., until no more suspended tasks remain).

Accordingly, a task is prevented from being added to the ready queue, which is common across the CPs 114a, 114b, 114c, if the latch is not going to be free (because it is being used by a previous task). This eliminates the overhead of transferring tasks to a ready list and the CPs when the latch is not available (e.g., when the previous task has not been completed).

In the example of FIG. 1, task 110a is suspended waiting for latch 104a. Latch 104a is placed on the list of the CP dispatcher 102 and is placed on the ready queue 112. Task 110b is determined to be waiting on the same latch (i.e., latch 104a) as task 110a due to the fact that the same address for the latch is in the dispatcher's list. Task 110b is not put on the ready queue and instead remains on the suspended queue 108. Task 110c and task 110d are found to not have the same latch address as task 110a, task 110b, or any other latch in the list of the CP dispatcher 102, so the address of latches for tasks 110c and 110d are added to the CP dispatcher 102 list and the tasks are placed in the ready queue 112.

In this example, the CP 110a is free to remove task 110a from the ready queue 112 and to start executing task 110a, which at some point shortly after starting, the resource becomes locked. If task 110b had also been in the ready queue (without using the present techniques) the CP 110b could have removed it from the ready queue and started to execute task 110b only to find that task 110b needs the same resource as task 110a on the CP 114a which causes the CP 114b to do the extra work of returning task 110b to the suspended queue 108. As a result of the present techniques, task 110b is not placed on the ready queue 112 on the same pass through the dispatching code as task 110a was placed on the ready queue 112. This enables the CP 114b to go directly to executing task 110c or task 110d.

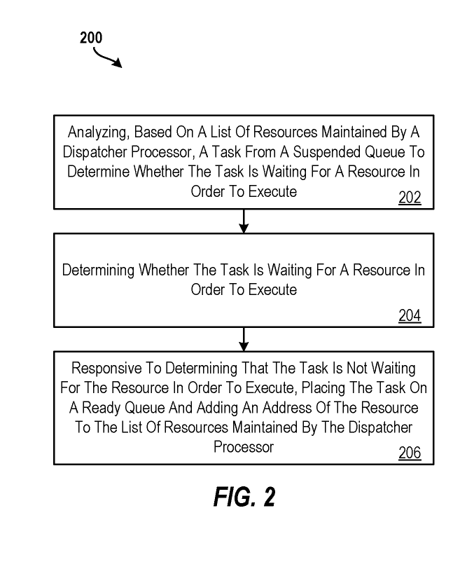

FIG. 2 illustrates a flow diagram of a method 200 for fast task dispatching using a dispatching processor according to examples of the present disclosure. It should be appreciated that the method 200 may be performed, for example, by the processing system 100 of FIG. 1, by the processing system 20 of FIG. 2, or by another suitable processing system.

At block 202, the method 200 includes analyzing, based on a list of resources maintained by the dispatcher processor, a task from a suspended queue to determine whether the task is waiting for a resource in order to execute.

At block 204, the method 200 includes determining whether the task is waiting for a resource in order to execute. According to some embodiments of the present disclosure, determining whether the task is waiting for the resource in order to execute includes comparing the resource of the task against the list of resources maintained by the dispatcher processor to determine whether the resource of the task is on the list of resources maintained by the dispatcher processor.

At block 206, the method 200 includes responsive to determining that the task is not waiting for the resource in order to execute, placing the task on a ready queue and adding an address of the resource to the list of resources maintained by the dispatcher processor. The list of resources may be a list of addresses of resources and may be stored in an array.

Additional processes also may be included. For example, the method 200 may include, responsive to determining that the task is waiting for the resource in order to execute, leaving the task on the suspended queue.

In another example, where the resource is a first resource, the method 300 includes analyzing, based on the list of resources maintained by the dispatcher processor, an additional task from the suspended queue to determine whether the additional task is waiting for the first resource in order to execute. In such cases, the method 300 may further include, responsive to determining that the additional task is waiting for the first resource in order to execute, leaving the task on the suspended queue. Additionally, the method 300 may include, responsive to determining that the additional task is not waiting for the first resource in order to execute, placing the additional task on the ready queue and adding an address of a second resource to the list of resources maintained by the dispatcher processor.

It should be understood that the processes depicted in FIG. 2 represent illustrations, and that other processes may be added or existing processes may be removed, modified, or rearranged without departing from the scope and spirit of the present disclosure.

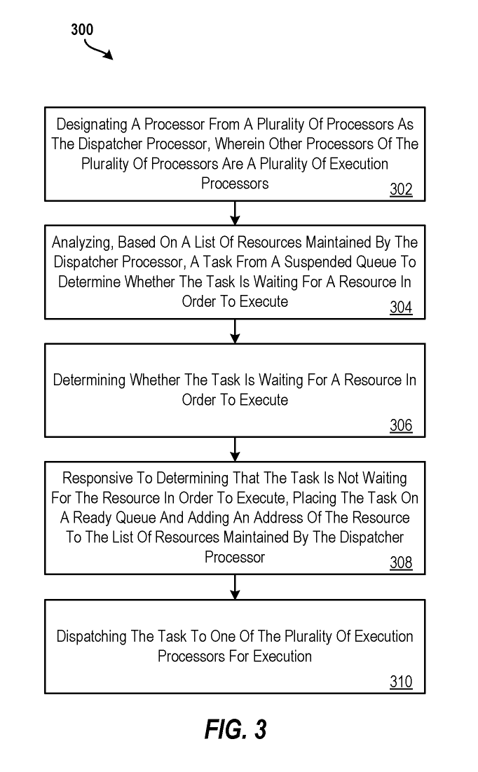

FIG. 3 illustrates a flow diagram of a method 300 for fast task dispatching using a dispatching processor according to examples of the present disclosure. It should be appreciated that the method 300 may be performed, for example, by the processing system 100 of FIG. 1, by the processing system 20 of FIG. 2, or by another suitable processing system.

At block 302, the method 300 includes designating a processor from a plurality of processors as a dispatcher processor, wherein other processors of the plurality of processors are a plurality of execution processors.

At block 304, the method 300 includes analyzing, based on a list of resources maintained by the dispatcher processor, a task from a suspended queue to determine whether the task is waiting for a resource in order to execute.

At block 306, the method 300 includes determining whether the task is waiting for a resource in order to execute.

At block 308, the method 300 includes responsive to determining that the task is not waiting for the resource in order to execute, placing the task on a ready queue and adding an address of the resource to the list of resources maintained by the dispatcher processor.

At block 310, the method 300 includes dispatching the task to one of the plurality of execution processors for execution. In some examples, at least one of the plurality of execution processors is enabled to remove the task from the ready queue and to start executing the task.

Additional processes also may be included, and it should be understood that the processes depicted in FIG. 3 represent illustrations, and that other processes may be added or existing processes may be removed, modified, or rearranged without departing from the scope and spirit of the present disclosure.

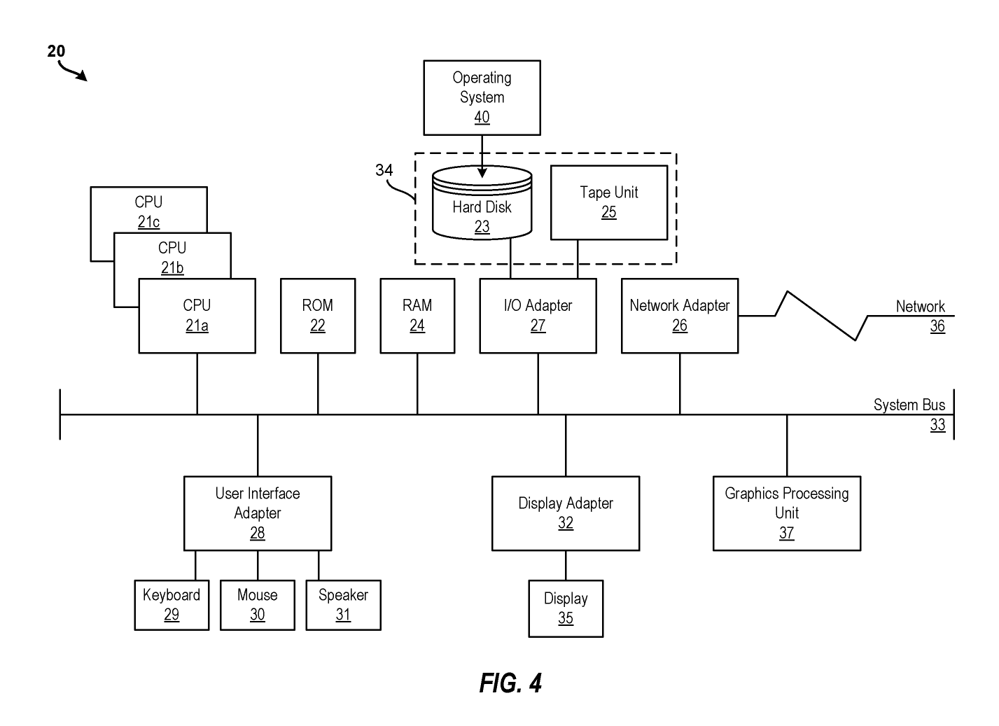

It is understood in advance that the present disclosure is capable of being implemented in conjunction with any other type of computing environment now known or later developed. For example, FIG. 4 illustrates a block diagram of a processing system 20 for implementing the techniques described herein. In examples, processing system 20 has one or more central processing units (processors) 21a, 21b, 21c, etc. (collectively or generically referred to as processor(s) 21 and/or as processing device(s)). In aspects of the present disclosure, each processor 21 may include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and may include a basic input/output system (BIOS), which controls certain basic functions of processing system 20.

Further illustrated are an input/output (I/O) adapter 27 and a communications adapter 26 coupled to system bus 33. I/O adapter 27 may be a small computer system interface (SCSI) adapter that communicates with a hard disk 23 and/or a tape storage drive 25 or any other similar component. I/O adapter 27, hard disk 23, and tape storage device 25 are collectively referred to herein as mass storage 34. Operating system 40 for execution on processing system 20 may be stored in mass storage 34. A network adapter 26 interconnects system bus 33 with an outside network 36 enabling processing system 20 to communicate with other such systems.

A display (e.g., a display monitor) 35 is connected to system bus 33 by display adaptor 32, which may include a graphics adapter to improve the performance of graphics intensive applications and a video controller. In one aspect of the present disclosure, adapters 26, 27, and/or 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 may be interconnected to system bus 33 via user interface adapter 28, which may include, for example, a Super I/O chip integrating multiple device adapters into a single integrated circuit.

In some aspects of the present disclosure, processing system 20 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing, and has a highly parallel structure that makes it more effective than general-purpose CPUs for algorithms where processing of large blocks of data is done in parallel.

Thus, as configured herein, processing system 20 includes processing capability in the form of processors 21, storage capability including system memory (e.g., RAM 24), and mass storage 34, input means such as keyboard 29 and mouse 30, and output capability including speaker 31 and display 35. In some aspects of the present disclosure, a portion of system memory (e.g., RAM 24) and mass storage 34 collectively store an operating system such as the AIX® operating system from IBM Corporation to coordinate the functions of the various components shown in processing system 20.

The present techniques may be implemented as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to aspects of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

What is claimed is:

1. A computer-implemented method for fast task dispatching using a dispatching processor, the method comprising:
analyzing, based on a list of resources maintained by a dispatcher processor, a task from a suspended queue to determine whether the task is waiting for a resource in order to execute;
determining whether the task is waiting for a resource in order to execute;
responsive to determining that the task is not waiting for the resource in order to execute, placing the task on a ready queue and adding an address of the resource to the list of resources maintained by the dispatcher processor; and
dispatching the task to one of a plurality of execution processors for execution.

2. The computer-implemented method of claim 1, further comprising, responsive to determining that the task is waiting for the resource in order to execute, leaving the task on the suspended queue.

3. The computer-implemented method of claim 1, wherein the list of resources maintained by the dispatcher processor comprises a list of addresses of resources stored in an array.

4. The computer-implemented method of claim 1, wherein the resource is a first resource, the method further comprising analyzing, based on the list of resources maintained by the dispatcher processor, an additional task from the suspended queue to determine whether the additional task is waiting for the first resource in order to execute.

5. The computer-implemented method of claim 4, further comprising, responsive to determining that the additional task is waiting for the first resource in order to execute, leaving the task on the suspended queue.

6. The computer-implemented method of claim 5, further comprising, responsive to determining that the additional task is not waiting for the first resource in order to execute, placing the additional task on the ready queue and adding an address of a second resource to the list of resources maintained by the dispatcher processor.

7. The computer-implemented method of claim 1, further comprising enabling the plurality of execution processors to remove the task from the ready queue and to start executing the task.

8. The computer-implemented method of claim 1, wherein determining whether the task is waiting for the resource in order to execute further comprises comparing the resource of the task against the list of resources maintained by the dispatcher processor to determine whether the resource of the task is on the list of resources maintained by the dispatcher processor.

9. The computer-implemented method of claim 1, further comprising designating a processor from a plurality of processors as the dispatcher processor, wherein other processors of the plurality of processors are the plurality of execution processors.

10. A system for fast task dispatching using a dispatching processor, the system comprising:
a memory comprising computer readable instructions; and
a processing device for executing the computer readable instructions for performing a method, the method comprising:
analyzing, based on a list of resources maintained by a dispatcher processor, a task from a suspended queue to determine whether the task is waiting for a resource in order to execute;
determining whether the task is waiting for a resource in order to execute;
responsive to determining that the task is not waiting for the resource in order to execute, placing the task on a ready queue and adding an address of the resource to the list of resources maintained by the dispatcher processor; and
dispatching the task to one of a plurality of execution processors for execution.

11. The system of claim 10, the method further comprising, responsive to determining that the task is waiting for the resource in order to execute, leaving the task on the suspended queue.

12. The system of claim 10, wherein the list of resources maintained by the dispatcher processor comprises a list of addresses of resources stored in an array.

13. The system of claim 10, wherein the resource is a first resource, the method further comprising analyzing, based on the list of resources maintained by the dispatcher processor, an additional task from the suspended queue to determine whether the additional task is waiting for the first resource in order to execute.

14. The system of claim 13, the method further comprising, responsive to determining that the additional task is waiting for the first resource in order to execute, leaving the task on the suspended queue.

15. The system of claim 14, the method further comprising, responsive to determining that the additional task is not waiting for the first resource in order to execute, placing the additional task on the ready queue and adding an address of a second resource to the list of resources maintained by the dispatcher processor.

16. The system of claim 10, the method further comprising enabling the plurality of execution processors to remove the task from the ready queue and to start executing the task.

17. The system of claim 10, wherein determining whether the task is waiting for the resource in order to execute further comprises comparing the resource of the task against the list of resources maintained by the dispatcher processor to determine whether the resource of the task is on the list of resources maintained by the dispatcher processor.

18. The system of claim 10, the method further comprising designating a processor from a plurality of processors as the dispatcher processor, wherein other processors of the plurality of processors are the plurality of execution processors.

19. A computer program product for fast task dispatching using a dispatching processor, the computer program product comprising:
a computer readable storage medium having program instructions embodied therewith, the program instructions executable by a processing device to cause the processing device to perform a method comprising:
analyzing, based on a list of resources maintained by a dispatcher processor, a task from a suspended queue to determine whether the task is waiting for a resource in order to execute;
determining whether the task is waiting for a resource in order to execute;
responsive to determining that the task is not waiting for the resource in order to execute, placing the task on a ready queue and adding an address of the resource to the list of resources maintained by the dispatcher processor; and
dispatching the task to one of a plurality of execution processors for execution.

20. The computer program product of claim 19, the method further comprising, responsive to determining that the task is waiting for the resource in order to execute, leaving the task on the suspended queue.
